(19) United States
(12) Patent Application Publication
(10) Pub. No.: US 2025/0300309 A1
(43) Pub. Date: Sep. 25, 2025

(54) ELECTRODE STACK

(71) Applicants: TOYOTA JIDOSHA KABUSHIKI KAISHA, Aichi-ken (JP); Panasonic Holdings Corporation, Osaka (JP)

(72) Inventors: Ryuto SAKAMOTO, Okazaki-shi (JP); Ryo KAGAMI, Ichinomiya-shi (JP); Akio MITSUI, Anjo-shi (JP); Kenji NAGAO, Moriguchi-shi (JP); Yuta SUGIMOTO, Nishinomiya-shi (JP)

(21) Appl. No.: 19/080,935

(22) Filed: Mar. 17, 2025

(30) Foreign Application Priority Data
Mar. 19, 2024 (JP) 2024-043793
Jan. 23, 2025 (JP) 2025-010121

(51) Int. Cl. H01M 50/296; H01M 50/538

(52) U.S. Cl. CPC H01M 50/296; H01M 50/538

(57) ABSTRACT

It is an object of the present disclosure to provide an electrode stack that can reduce damage to multiple electrode collector layers (positive electrode collector layers and/or negative electrode collector layers) or collector tabs connected to electrode collector layers. An electrode stack having a plurality of stacked battery units, wherein the plurality of stacked battery units each comprise at least a negative electrode collector layer and a positive electrode collector layer, (i) the negative electrode collector layer extends from the first edge of the stacked battery unit, and the plurality of stacked battery units are stacked together so that the plurality of first edges are in an inclined arrangement, and/or (ii) the positive electrode collector layer extends from the second edge of the stacked battery unit, and the plurality of stacked battery units are stacked together so that the plurality of second edges are in an inclined arrangement.

### FIELD

The present disclosure relates to an electrode stack.

### BACKGROUND

An electrode stack in a battery has a plurality of stacked battery units, the plurality of stacked battery units each generally comprising a positive electrode collector layer, a positive electrode active material layer, an electrolyte layer, a negative electrode active material layer and a negative electrode collector layer. The electrode stack of a battery is sealed in the interior space in a manner enclosed by an exterior material such as a laminate film, with the following various types of such batteries being known.

PTL 1 discloses a battery cell having an electrode assembly with a positive electrode/separation membrane/negative electrode structure housed in a battery case comprising a laminated sheet with a resin layer and a metal layer, while being connected to electrode terminals protruding out of the battery case, wherein the electrode assembly has a separation membrane sandwiched between the positive electrode and negative electrode, each of which is a current collector coated with a mixture comprising an electrode active material, at least part of the inner surface of the battery case, corresponding to the outer peripheral surface of the electrode assembly, having an inclined structure where the width widens toward the top or an inclined structure where the width widens toward the bottom (in a vertical cross section) and the outer peripheral surface of the electrode assembly also having an upward inclined structure or downward inclined structure corresponding to the inner surface of the battery case. It is stated that the battery cell of PTL 1 increases the volume of the battery cell by a safer and more efficient method, helping to ensure safety of the battery cell.

PTL 2 discloses a battery comprising an electrode body, a plurality of collector tabs extending from the side section of the electrode body, a plurality of collector terminals connected to the collector tabs, and a laminate film housing the electrode body and the plurality of collector tabs, wherein the collector tabs each have a base section at the edge of the electrode body side, a connector for connection with the collector terminal, and a middle part that links the base section and the connector, each of the plurality of collector tabs has a stack connecting part where the connectors are stacked in the thickness direction, and each of the collector terminals has at least a first side, a second side opposite the first side, and a third side connecting the first side and second side and facing the side section of the electrode body, with the seal sections of the laminate film being disposed respectively on the first side and second side and the main side of the stack connecting part being disposed on the third side. The battery of PTL 2 provides a battery having less collector tab-induced laminate film damage.

### CITATION LIST

### Patent Literature

[PTL 1] Japanese Patent Public Inspection No. 2014-532262
[PTL 2] Japanese Unexamined Patent Publication No. 2024-4737

### SUMMARY

### Technical Problem

In a battery having the construction of PTL 2, for example, when an electrode collector layer (a negative electrode collector layer and/or positive electrode collector layer), or a collector tab connected to an electrode collector layer is stacked as a foil and connected to a collector terminal at the stack connecting part, the electrode collector layer or the collector tab connected to the electrode collector layer is bent with high curvature, creating a load, and thereby resulting in damage to the electrode collector layer or the collector tab connected to the electrode collector layer.

It is therefore an object of the present disclosure to provide an electrode stack that can reduce damage to multiple electrode collector layers (positive electrode collector layers and/or negative electrode collector layers) or collector tabs connected to electrode collector layers.

### Solution to Problem

The present disclosure achieves the object described above by the following means.

### <Aspect 1>

An electrode stack having a plurality of stacked battery units,
wherein the plurality of stacked battery units each have at least a negative electrode collector layer, a negative electrode active material layer, a solid electrolyte layer, a positive electrode active material layer and a positive electrode collector layer, in that order,
(i) the negative electrode collector layer extends from the first edge of the stacked battery unit, and the plurality of stacked battery units are stacked together so that the plurality of first edges are in an inclined arrangement, and/or
(ii) the positive electrode collector layer extends from the second edge of the stacked battery unit, and the plurality of stacked battery units are stacked together so that the plurality of second edges are in an inclined arrangement.

### <Aspect 2>

The electrode stack according to aspect 1, wherein the plurality of stacked battery units all have the same shape.

### <Aspect 3>

The electrode stack according to aspect 1 or 2,
which satisfies (i) and (ii) above, and
wherein the first edges and second edges are mutually opposite edges of the stacked battery unit.

### <Aspect 4>

A solid-state battery comprising:
an electrode stack according to any one of aspects 1 to 3, collector terminals, and
a laminate film sealing the electrode stack together with the collector terminals,
wherein:
(a) the negative electrode collector layers of the plurality of stacked battery units or the negative electrode collector tabs connected to the negative electrode collector layers are mutually stacked as a foil to form a negative electrode stack connecting part, and the negative electrode collector layers and/or the negative electrode collector tabs are bent so that the negative electrode stack connecting part is connected to the end face of the collector terminal facing the first edge of the electrode stack terminal, at the extending side of the negative electrode stack connecting part, where the extending side of the negative electrode stack connecting part is the surface on the side among the sides of the negative electrode stack connecting part where the plurality of first edges extend, and which are disposed at an inclination,
   and/or
(b) the positive electrode collector layers of the plurality of stacked battery units or the positive electrode collector tabs connected to the positive electrode collector layers are mutually stacked as a foil to form a positive electrode stack connecting part, and the positive electrode collector layers and/or positive electrode collector tabs are bent so that the positive electrode stack connecting part is connected to the end face of the collector terminal facing the second edge of the electrode stack terminal, at the extending side of the positive electrode stack connecting part, where the extending side of the negative electrode stack connecting part is the surface on the side among the sides of the negative electrode stack connecting part where the plurality of second edges extend, and which are disposed at an inclination.

### Advantageous Effects of Invention

According to the electrode stack of the disclosure it is possible to reduce damage to multiple electrode collector layers (positive electrode collector layers and/or negative electrode collector layers) or collector tabs connected to the electrode collector layers.

### BRIEF DESCRIPTION OF DRAWINGS

FIG. 1A and FIG. 1B are a cross-sectional schematic diagram for illustration of the electrode stack of the disclosure.

FIG. 2 is a cross-sectional schematic diagram for illustration of the electrode stack of the disclosure.

FIG. 3A and FIG. 3B are a schematic diagram for illustration of the electrode stack of the disclosure.

FIG. 4A and FIG. 4B are a cross-sectional schematic diagram for illustration of a stacked battery unit having an electrode stack of the disclosure.

FIG. 5A and FIG. 5B are a schematic diagram for illustration of the solid state battery of the disclosure.

FIG. 6A is a cross-sectional schematic diagram for illustration of the solid state battery of the disclosure. FIG. 6B is a cross-sectional schematic diagram for illustration of a conventional solid-state battery.

### DESCRIPTION OF EMBODIMENTS

Embodiments of the disclosure will now be explained in detail. The present disclosure is not limited to the embodiments described below, however, and various modifications may be implemented which do not depart from the gist thereof. Similar elements in the drawings are indicated by like reference numerals and will be explained only once.

### <Electrode Stack>

The electrode stack of the disclosure has a plurality of stacked battery units,
wherein the plurality of stacked battery units each have at least a negative electrode collector layer, a negative electrode active material layer, a solid electrolyte layer, a positive electrode active material layer and a positive electrode collector layer, in that order,
(i) the negative electrode collector layer extends from the first edge of the stacked battery unit, and the plurality of stacked battery units are stacked together so that the plurality of first edges are in an inclined arrangement, and/or
(ii) the positive electrode collector layer extends from the second edge of the stacked battery unit, and the plurality of stacked battery units are stacked together so that the plurality of second edges are in an inclined arrangement.

With the electrode stack of the disclosure it is possible to reduce damage to multiple electrode collector layers (positive electrode collector layers and/or negative electrode collector layers) or collector tabs connected to electrode collector layers.

Without being limited to theory, it is presumed that in a battery where a plurality of electrode collector layers or collector tabs connected to the electrode collector layers are stacked as a foil to form a stack connecting part, with the electrode collector layers extending from the edges of the stacked battery unit, and the plurality of stacked battery units being stacked together with the edges of the plurality of stacked battery units in an inclined arrangement, if the electrode collector layers or the collector tabs connected to the electrode collector layers are bent and connected to the collector terminals, for example, the curvature of the bent electrode collector layers or the collector tabs connected to the electrode collector layers is relaxed, and especially the curvature of the electrode collector layers or the collector tabs connected to the electrode collector layers on the side opposite the extending side of the stack connecting part is relaxed, thus making it possible to reduce damage to the plurality of electrode collector layers or collector tabs connected to the electrode collector layers. The extending side of the stack connecting part is the surface among the surfaces of the stack connecting part, on the side where the first edge and/or second edge are disposed at an inclination.

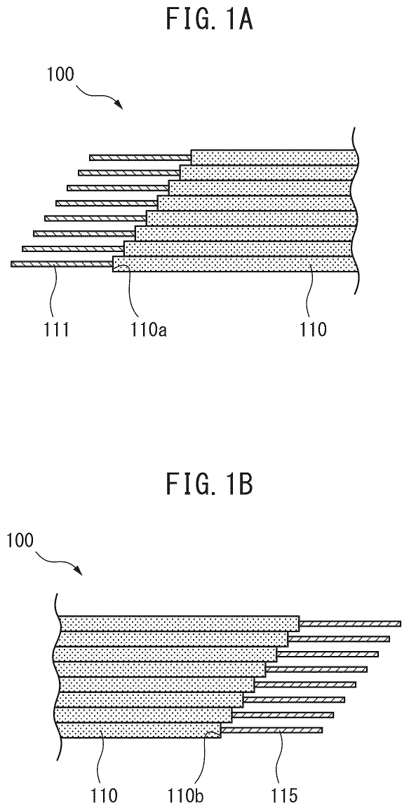

FIG. 1A and FIG. 1B are a cross-sectional schematic diagram showing one aspect, though not limitative, of the electrode stack of the disclosure.

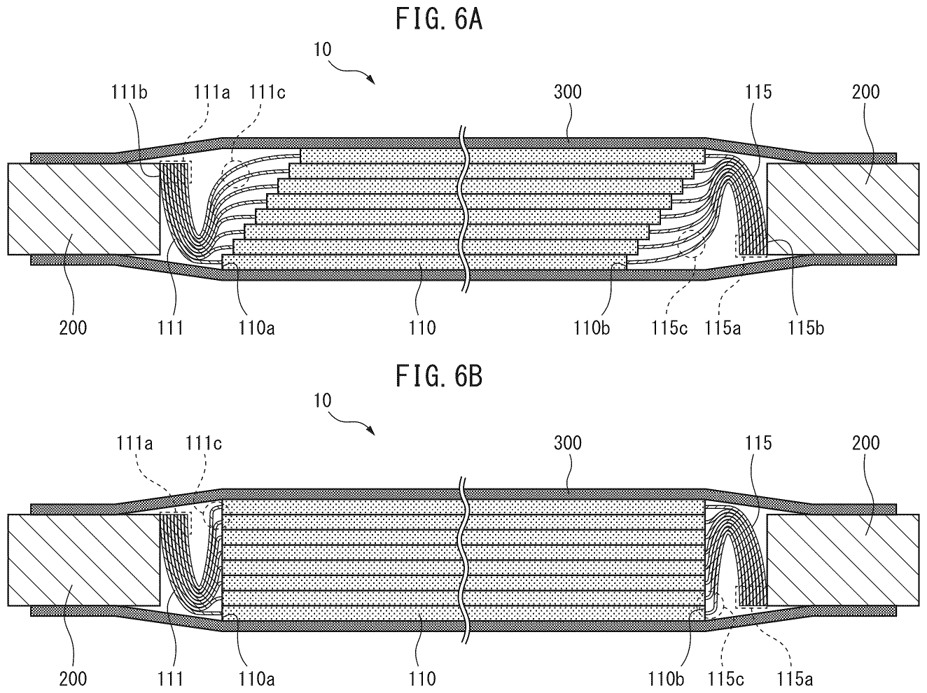

The stacked battery unit 110 shown in FIG. 1A will be explained first as it relates to the electrode stack of the disclosure. The electrode stack 100 has a plurality of stacked battery units 110, the negative electrode collector layers 111 extending from the first edges 110a of the stacked battery units 110. The stacked battery units 110 are stacked together with the first edges 110a of the plurality of stacked battery units 110 in an inclined arrangement. The stacked battery units 110 of the electrode stack 100 are in an inclined arrangement, so that even when a plurality of negative electrode collector layers are stacked as a foil and bent and connected to a collector terminal, for example, the curvature of the negative electrode collector layers is relaxed, and in particular the curvature of the negative electrode collector layers on the side opposite from the extending sides of the negative electrode stack connecting parts (especially at 111c depicted in FIG. 6A) is relaxed, thereby helping to reduce damage to the negative electrode collector layers.

The stacked battery unit 110 shown in FIG. 1B will now be explained as it relates to the electrode stack of the disclosure. The positive electrode collector layers 115 extend from the second edges 110b of the stacked battery units 110. The stacked battery units 110 are stacked together with the second edges 110b of the plurality of stacked battery units 110 in an inclined arrangement. The stacked battery units 110 of the electrode stack 100 are in an inclined arrangement, so that even when a plurality of positive electrode collector layers are stacked as a foil and bent and connected to a collector terminal, for example, the curvature of the positive electrode collector layers is relaxed, and in particular the curvature of the positive electrode collector layers on the side opposite from the extending sides of the positive electrode stack connecting parts (especially at 115c depicted in FIG. 6A) is relaxed, thereby helping to reduce damage to the positive electrode collector layers.

An electrode stack with the first edges of the stacked battery units in an inclined arrangement and an electrode stack with the second edges of the stacked battery units in an inclined arrangement were explained using FIG. 1A and FIG. 1B, but the electrode stack of the disclosure is not particularly restricted and may have either or both the first edges and/or second edges of the stacked battery units arranged at an inclination. Moreover it is not necessary for all of the first edges and/or second edges of the stacked battery units to be in an inclined arrangement, and only some of them may be arranged at an inclination.

According to the disclosure, the plurality of stacked battery units preferably all have the same shape from the viewpoint of productivity, although this is not limitative. There are no particular restrictions on having “the same shape”, and the shapes may include differences naturally produced during production of the stacked battery units.

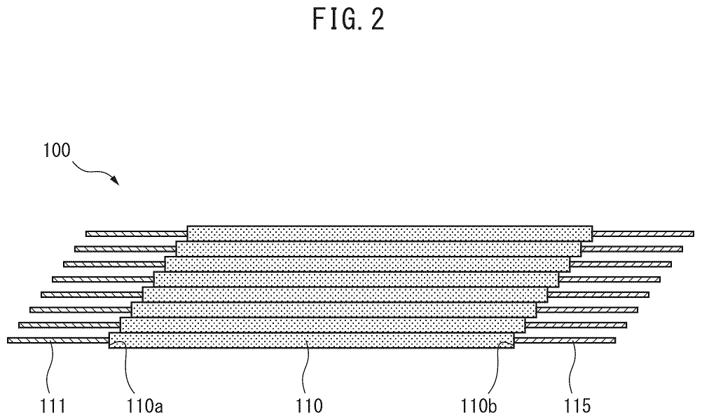

FIG. 2 is a cross-sectional schematic diagram showing one aspect, though not limitative, of the electrode stack of the disclosure.

The electrode stack 100 shown in FIG. 2 has a plurality of stacked battery units 110 of the same shape, the negative electrode collector layers 111 extending from the first edges 110a of the stacked battery units 110, and the positive electrode collector layers 115 extending from the second edges 110b of the stacked battery units 110. The first edges 110a of the plurality of stacked battery units 110 are in an inclined arrangement, with the stacked battery units 110 being stacked together so that the second edges 110b of the plurality of stacked battery units 110 are in an inclined arrangement. By having the stacked battery units 110 of the electrode stack 100 in an inclined arrangement, even when a plurality of negative electrode collector layers and positive electrode collector layers are each stacked as a foil and bent and connected to collector terminals, for example, the curvature of the negative electrode collector layers and positive electrode collector layers is relaxed, thereby helping to reduce damage to the negative electrode collector layers and positive electrode collector layers.

If the plurality of stacked battery units all have the same shape, then it will be possible to produce an electrode stack with better productivity compared to stacking stacked battery units with different shapes and forming an inclined structure at the edges of the electrode stack. Moreover if the plurality of stacked battery units all have the same shape, then when the first edges 110a of the stacked battery units 110 are in an inclined arrangement, for example, it is possible to form an inclined structure even at the opposite edges of the stacked battery units.

According to the disclosure, the first edges and second edges are not particularly restricted and may be mutually opposite edges of the stacked battery units. Moreover it is not necessary for all of the first edges and second edges to be in an inclined arrangement, and only some of each of them may be arranged at an inclination.

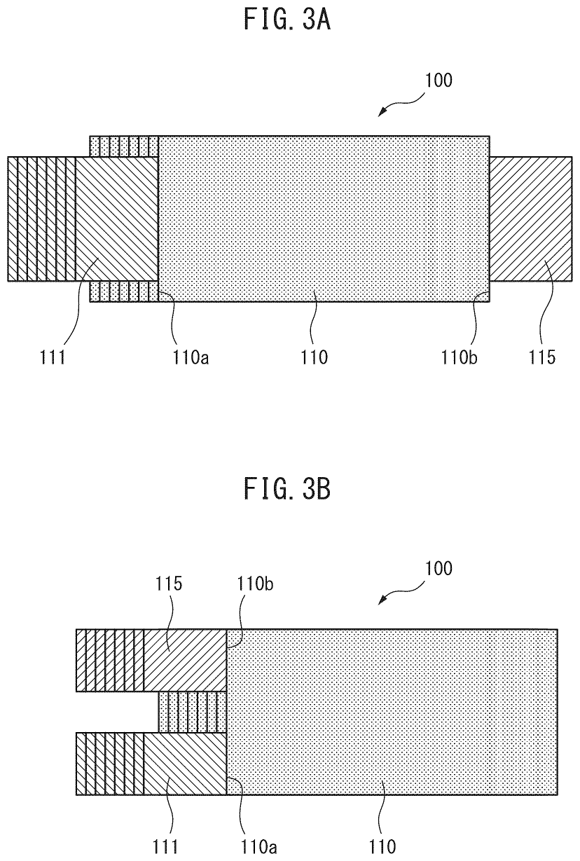

FIG. 3A and FIG. 3B are schematic diagrams each showing one aspect of the electrode stack of the disclosure, depicting the electrode stack in the direction of stacking, but without being limitative.

In the electrode stack 100 shown in FIG. 3A, the negative electrode collector layers 111 and positive electrode collector layers 115 extending from the stacked battery units 110 extend from opposite edges of the stacked battery units 110, the first edges 110a and second edges 110b of the stacked battery units being the mutually opposite edges of the stacked battery units 110. In the electrode stack 100 shown in FIG. 3B, on the other hand, the negative electrode collector layers 111 and positive electrode collector layers 115 extending from the stacked battery units 110 extend from edges on the same side of the stacked battery units 110, the first edges 110a and second edges 110b of the stacked battery units being edges on the same side of the stacked battery units 110. Each electrode stack 100 shown in FIG. 3A and FIG. 3B has the stacked battery units 110 stacked together so that the first edges 110a of the plurality of stacked battery units 110 are in an inclined arrangement, and the second edges 110b of the plurality of stacked battery units 110 are in an inclined arrangement, and therefore even when a plurality of negative electrode collector layers and positive electrode collector layers are each stacked as a foil and bent and connected to collector terminals, for example, the curvature of the negative electrode collector layers and positive electrode collector layers is relaxed, thereby helping to reduce damage to the negative electrode collector layers and positive electrode collector layers. If the first edges and second edges are mutually opposite edges of the stacked battery units, then it is possible to arrange the positive electrode terminals and negative electrode terminals of the battery at opposite edges of the battery.

It is not necessary for all of the first edges and second edges to be in an inclined arrangement, and only some of each of them may be arranged at an inclination.

According to the disclosure, the stacked battery unit comprises at least a negative electrode collector layer, a negative electrode active material layer, a solid electrolyte layer, a positive electrode active material layer and a positive electrode collector layer, in that order.

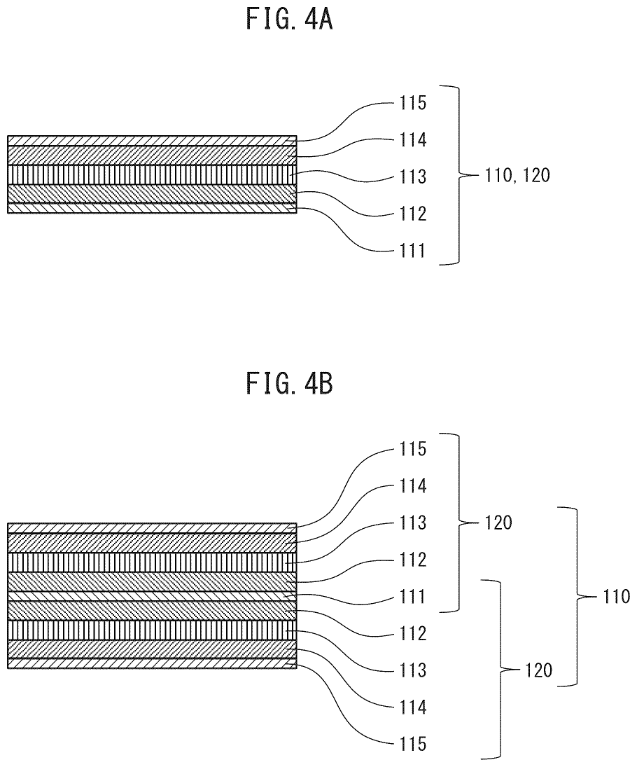

FIG. 4A and FIG. 4B are a cross-sectional schematic diagram showing one aspect, though not limitative, of a stacked battery unit in the electrode stack of the disclosure.

The stacked battery unit 110 shown in FIG. 4A comprises a negative electrode collector layer 111, a negative electrode active material layer 112, a solid electrolyte layer 113, a positive electrode active material layer 114 and a positive electrode collector layer 115. The stacked battery unit 110 shown in FIG. 4B has a positive electrode collector layer 115, a positive electrode active material layer 114, a solid electrolyte layer 113, a negative electrode active material layer 112, a negative electrode collector layer 111, a negative electrode active material layer 112, a solid electrolyte layer 113, a positive electrode active material layer 114 and a positive electrode collector layer 115. Each stacked battery unit shown in FIG. 4A and FIG. 4B includes a negative electrode collector layer, a negative electrode active material layer, a solid electrolyte layer, a positive electrode active material layer and a positive electrode collector layer, in that order. The stacked battery unit is not particularly restricted and may be a unit cell having a negative electrode collector layer, a negative electrode active material layer, a solid electrolyte layer, a positive electrode active material layer, and a positive electrode collector layer, in that order, or it may be a plurality of such unit cells.

### <Solid-State Battery>

The solid state battery of the disclosure is a solid-state battery comprising:
the aforementioned electrode stack,
collector terminals, and
a laminate film sealing the electrode stack together with the collector terminals,
wherein:
(a) the negative electrode collector layers of the plurality of stacked battery units or the negative electrode collector tabs connected to the negative electrode collector layers are mutually stacked as a foil to form a negative electrode stack connecting part, and the negative electrode collector layers and/or the negative electrode collector tabs are bent so that the negative electrode stack connecting part is connected to the end face of the collector terminal facing the first edge of the electrode stack terminal, at the extending side of the negative electrode stack connecting part, where the extending side of the negative electrode stack connecting part is the surface on the side among the sides of the negative electrode stack connecting part where the plurality of first edges extend, which are disposed at an inclination,
   and/or
(b) the positive electrode collector layers of the plurality of stacked battery units or the positive electrode collector tabs connected to the positive electrode collector layers are mutually stacked as a foil to form a positive electrode stack connecting part, and the positive electrode collector layers and/or positive electrode collector tabs are bent so that the positive electrode stack connecting part is connected to the end face of the collector terminal facing the second edge of the electrode stack terminal, at the extending side of the positive electrode stack connecting part, where the extending side of the negative electrode stack connecting part is the surface on the side among the sides of the negative electrode stack connecting part where the plurality of second edges extend, which are disposed at an inclination.

With the solid state battery of the disclosure it is possible to reduce damage to a plurality of electrode collector layers or collector tabs connected to the electrode collector layers.

When an electrode collector layer or collector tab connected to an electrode collector layer in a solid-state battery suffers damage, the resistance of the solid-state battery increases and the capacity of the solid-state battery decreases, while short circuiting of the solid-state battery is also a concern. With the solid state battery of the disclosure it is possible to reduce damage to a plurality of electrode collector layers or collector tabs connected to the electrode collector layers, which is thus expected to eliminate such concerns.

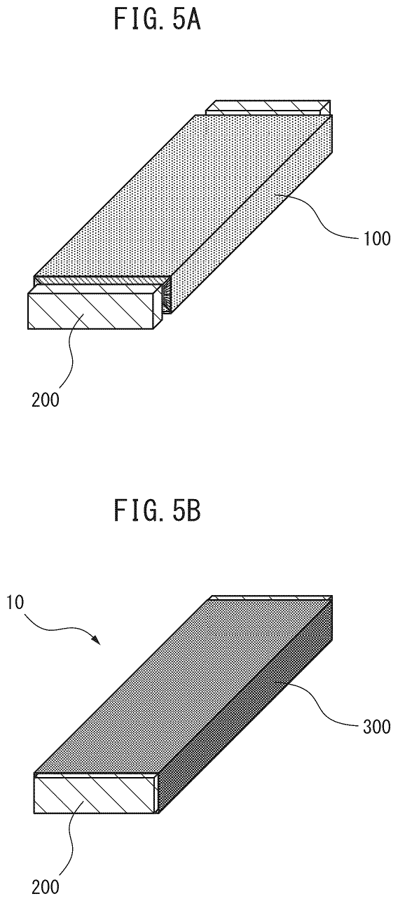

FIG. 5A and FIG. 5B are a schematic diagram showing one aspect of the solid state battery of the disclosure, without being limitative, as a view of the entire solid-state battery.

FIG. 5A shows an electrode stack 100 and a collector terminal 200. The electrode stack 100 is electrically connected with the collector terminal 200 on one side, by a negative electrode collector layer extending from the first edge of the plurality of stacked battery units. The electrode stack 100 is also electrically connected with the collector terminal 200 by a positive electrode collector layer extending from the second edge of the plurality of stacked battery units, on the side opposite from the aforementioned side. FIG. 5B shows a solid-state battery 10. The solid-state battery 10 has an electrode stack 100, a collector terminal 200 and a laminate film 300. The solid-state battery 10 has the electrode stack 100 and collector terminal 200 sealed by the laminate film 300.

FIG. 6A is a cross-sectional schematic diagram showing one aspect, though not limitative, of the solid state battery of the disclosure.

The region near the first edges 110a of the plurality of stacked battery units 110 of the solid-state battery 10 will be explained first. The negative electrode collector layers 111 of the plurality of stacked battery units 110 are stacked as a foil to form a negative electrode stack connecting part 111a. The negative electrode stack connecting part 111a has the negative electrode collector layers 111 bent and connected to the end face of the collector terminal 200 facing the first edges 110a of the electrode stack 100, at the extending side 111b of the negative electrode stack connecting part. The extending side 111b of the negative electrode stack connecting part is the surface among the surfaces of the negative electrode stack connecting part 111a, on the side where the plurality of first edges 110a disposed at an inclination extend. By using the electrode stack 100 stacked in a manner with the first edges 110a of the stacked battery units 110 arranged at an inclination, even if the solid-state battery has a negative electrode stack connecting part formed and the negative electrode collector layers are bent so that the negative electrode stack connecting part is connected to the end face of the collector terminal facing the first edges of the electrode stack, at the extending side of the negative electrode stack connecting part, the curvature of the bent negative electrode collector layers is relaxed, and especially the curvature of the bent negative electrode collector layers on the side opposite the extending side (111c in FIG. 6A) is relaxed, thereby making it possible to reduce damage to the plurality of negative electrode collector layers.

The region near the second edge 110b of the plurality of stacked battery units 110 of the solid-state battery 10 will be explained next. The positive electrode collector layers 115 of the plurality of stacked battery units 110 are stacked as a foil to form a positive electrode stack connecting part 115a. The positive electrode stack connecting part 115a has the positive electrode collector layers 115 bent and connected to the end face of the collector terminal 200 facing the second edges 110b of the electrode stack 100, at the extending side 115b of the positive electrode stack connecting part. The extending side 115b of the positive electrode stack connecting part is the surface among the surfaces of the positive electrode stack connecting part 115a, on the side where the plurality of second edges 110b disposed at an inclination extend. By using the electrode stack 100 stacked in a manner with the second edges of the stacked battery units 110 arranged at an inclination 110b, even if the solid-state battery has a positive electrode stack connecting part formed and the positive electrode collector layers are bent so that the positive electrode stack connecting part is connected to the end face of the collector terminal facing the second edges of the electrode stack, at the extending side of the positive electrode stack connecting part, the curvature of the bent positive electrode collector layers is relaxed, and especially the curvature of the bent positive electrode collector layers on the side opposite the extending side (115c in FIG. 6A) is relaxed, thereby making it possible to reduce damage to the plurality of positive electrode collector layers.

It is not necessary for all of the first edges and second edges to be in an inclined arrangement, and only some of each of them may be arranged at an inclination.

FIG. 6B is a cross-sectional schematic diagram showing one aspect, though not limitative, of a solid-state battery of the prior art.

The solid-state battery 10 of the prior art has a plurality of stacked battery units 110 stacked to form an electrode stack 100, without the first edges and second edges being arranged at an inclination, and having the first edges and second edges flush instead. The region near the first edges 110a of the plurality of stacked battery units 110 of the solid-state battery 10 will be explained first. The negative electrode collector layers 111 of the plurality of stacked battery units 110 are stacked as a foil to form a negative electrode stack connecting part 111a. The negative electrode stack connecting part 111a has the negative electrode collector layers 111 bent and connected to the end face of the collector terminal 200 facing the first edges 110a of the electrode stack 100. In a solid-state battery such as shown in FIG. 6B, the curvature of the bent negative electrode collector layers is increased, and in particular the curvature of the negative electrode collector layers is higher on the side further from the collector terminal of the negative electrode stack connecting part (111c in FIG. 6B), thereby damaging the negative electrode collector layers.

The region near the second edge 110b of the plurality of stacked battery units 110 of the solid-state battery 10 will be explained next. The positive electrode collector layer 115 of the plurality of stacked battery units 110 are stacked as a foil to form a positive electrode stack connecting part 115a. The positive electrode stack connecting part 115a has the positive electrode collector layer 115 bent and connected to the end face of the collector terminal 200 facing the second edge 110b of the electrode stack 100. In a solid-state battery such as shown in FIG. 6B, the curvature of the bent positive electrode collector layers is increased, and in particular the curvature of the positive electrode collector layers is higher on the side further from the collector terminal of the positive electrode stack connecting part (115c in FIG. 6B), thereby damaging the positive electrode collector layers.

### <Usage of Solid-State Battery>

The solid-state battery of the disclosure may be a car battery, for example, or it may be used as a power source for a non-vehicle traveling body (such as a railway car, ship or aircraft), or as a power source for an electrical product such as an information processing device.

### <Construction of Electrode Stack and Solid-State Battery>

The respective constructions of the electrode stack and solid-state battery will now be described.

The term “solid-state battery” as used herein refers to a battery using at least a solid electrolyte as the electrolyte, and the solid-state battery may also employ a combination of a solid electrolyte and a liquid electrolyte as the electrolyte. Alternatively, the solid-state battery of the disclosure may be an all-solid-state battery, i.e. a battery employing only a solid electrolyte as the electrolyte.

For the purpose of the disclosure, “mixture” means a composition that can form an electrode active material layer either by itself or by further comprising other components. Moreover, the term “mixture slurry” means a slurry that includes a dispersing medium in addition to the “mixture”, allowing it to form a positive electrode active material layer by being coated and dried.

The electrode stack has a plurality of stacked battery units. The solid-state battery has an electrode stack, collector terminals and a laminate film.

### <Stacked Battery Unit>

The stacked battery unit comprises a negative electrode collector layer, a negative electrode active material layer, a solid electrolyte layer, a positive electrode active material layer and a positive electrode collector layer.

### <Negative Electrode Collector Layer>

The material used in the negative electrode collector layer is not particularly restricted, and any one commonly used as a negative electrode collector in a solid-state battery may be employed as appropriate. The material used in the negative electrode collector layer may be Cu, Ni, Cr, Au, Pt, Ag, Al, Fe, Ti, Zn, Co, stainless steel or a carbon sheet, with no limitation to these. The negative electrode collector layer may also have a coating layer on the surface, in order to adjust the resistance.

The form of the negative electrode collector layer is not particularly restricted and may be, for example, a foil, sheet, mesh or the like. A foil is preferred among these.

The thickness of the negative electrode collector layer is not particularly restricted, and may be 0.1 μm or greater or 1 μm or greater, and 1 mm or smaller or 100 μm or smaller, for example.

### <Negative Electrode Active Material Layer>

The negative electrode active material layer is a layer that includes at least a negative electrode active material, and it may also optionally include a conductive aid, a binder and a solid electrolyte. The negative electrode active material layer may also contain other additives. The contents of the negative electrode active material, solid electrolyte, conductive aid and binder in the negative electrode active material layer may be determined as appropriate for the desired battery performance. For example, the content of the negative electrode active material may be 40 mass % or greater, 50 mass % or greater or 60 mass % or greater, and 100 mass % or lower or 90 mass % or lower, with respect to 100 mass % as the total negative electrode active material layer (solid content).

### (Negative Electrode Active Material)

The negative electrode active material used may be any of various substances whose potential for storing and releasing lithium ions (charge-discharge potential) is an electronegative potential compared to the positive electrode active material. The material for the negative electrode active material is not particularly restricted, and it may be lithium metal, or any material capable of occluding and releasing metal ions such as lithium ions. Examples of materials capable of occluding and releasing metal ions such as lithium ions include, but are not limited to, alloy-based negative electrode active materials and carbon materials, or lithium titanate (Li₄Ti₅O₁₂).

Alloy-based negative electrode active materials are not particularly restricted, and examples include Si alloy-based negative electrode active materials and Sn alloy-based negative electrode active materials. Si alloy-based negative electrode active materials include silicon, silicon oxides, silicon carbides, silicon nitrides, and their solid solutions. A Si alloy-based negative electrode active material may also include metal elements other than silicon, such as Fe, Co, Sb, Bi, Pb, Ni, Cu, Zn, Ge, In, Sn and Ti, for example. Sn alloy-based negative electrode active materials include tin, tin oxides, tin nitrides, and their solid solutions. A Sn alloy-based negative electrode active material may also include metal elements other than tin, such as Fe, Co, Sb, Bi, Pb, Ni, Cu, Zn, Ge, In, Ti and Si, for example.

Carbon materials are not particularly restricted and include hard carbon, soft carbon and graphite, for example.

The form of the negative electrode active material is not particularly restricted and may be any common form used as a negative electrode active material for a solid-state battery. The negative electrode active material may be particulate or in a sheet form, for example.

### (Solid Electrolyte)

The material of the solid electrolyte may be a sulfide solid electrolyte, an oxide solid electrolyte or a polymer electrolyte, for example, although this is not limitative.

Examples of sulfide solid electrolytes include, but are not limited to, sulfide-based amorphous solid electrolytes, sulfide-based crystalline solid electrolytes and argyrodite solid electrolytes. Specific examples of sulfide solid electrolytes include, but are not limited to, Li₂S—P₂S₅ (such as Li₇P₃S₁₁, Li₃PS₄ and Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (such as Li₁₃GeP₃S₁₆ and Li₁₀GeP₂S₁₂), LiI—Li₂S—P₂O₅, LiI—Li₃PO₄—P₂S₅ and Li₇₋ₓPS₆₋ₓClₓ, as well as combinations thereof.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ (PO₄)₃, Li₁₊ₓAlₓGe₂₋ₓ (PO₄)₃, Li₃PO₄ and Li₃₊ₓPO₄₋ₓNₓ (LiPON), as well as their combinations.

The sulfide solid electrolyte and oxide solid electrolyte may be glass or crystallized glass (glass ceramic).

Polymer electrolytes include, but are not limited to, polyethylene oxide (PEO) and polypropylene oxide (PPO), and their copolymers.

### (Conductive Aid)

The conductive aid is not particularly restricted. The conductive aid may be, but is not limited to, vapor-deposited carbon fiber (VGCF), acetylene black (AB), Ketjen black (KB), carbon nanotubes (CNT) or carbon nanofibers (CNF). The conductive aid may be particulate or filamentous, for example, and its size is not particularly restricted. The conductive aid is not particularly restricted and may be of a single type alone, or two or more different types may be used in combination.

### (Binder)

The binder is also not particularly restricted. Examples for the binder include, but are not limited to, materials such as polyvinylidene fluoride (PVdF), butadiene rubber (BR), polytetrafluoroethylene (PTFE), and styrene-butadiene rubber (SBR). The binder is not particularly restricted and may be of a single type alone, or two or more different types may be used in combination.

The form of the negative electrode active material layer is not particularly restricted, and it may be an essentially flat sheet-like negative electrode active material layer. The thickness of the negative electrode active material layer is not particularly restricted and may be 0.1 μm or greater, 1 μm or greater or 10 μm or greater, and 2 mm or smaller, 1 mm or smaller or 500 μm or smaller, for example.

The negative electrode active material layer can be produced by a publicly known method. For example, a negative electrode mixture containing the components mentioned above may be dry or wet molded to easily form a negative electrode active material layer. The negative electrode active material layer may be formed together with the negative electrode collector layer, or it be formed separately from the negative electrode collector layer.

### <Solid Electrolyte Layer>

The solid electrolyte layer includes at least a solid electrolyte, and it may also include a conductive aid or binder as necessary.

The solid electrolyte, conductive aid and binder may be selected with reference to the above description under “<Negative electrode active material layer>”.

The thickness of the solid electrolyte layer is not particularly restricted and may be 0.1 μm or greater, 1 μm or greater or 10 μm or greater, and 2 mm or smaller, 1 mm or smaller or 500 μm or smaller, for example.

The solid electrolyte layer can be easily formed by dry or wet molding of a solid electrolyte mixture comprising the solid electrolyte and a binder, for example.

### <Positive Electrode Active Material Layer>

The positive electrode active material layer is a layer that includes at least a positive electrode active material, and it may also optionally include a solid electrolyte, a conductive aid and a binder. The positive electrode active material layer may also contain other additives. The contents of the positive electrode active material, solid electrolyte, conductive aid and binder in the positive electrode active material layer may be determined as appropriate for the desired battery performance. For example, the content of the positive electrode active material may be 40 mass % or greater, 50 mass % or greater or 60 mass % or greater, and 100 mass % or lower or 90 mass % or lower, with respect to 100 mass % as the total positive electrode active material layer (solid content).

### (Positive Electrode Active Material)

The material for the positive electrode active material is not particularly restricted and may be one that is capable of occluding and releasing lithium ions. Examples of positive electrode active materials include, but are not limited to, lithium cobaltate (LiCoO₂), lithium nickelate (LiNiO₂), lithium manganate (LiMn₂O₄), lithium nickelate-cobaltate-manganate (NCM: LiCO_{1/3}Ni_{1/3}Mn_{1/3}O₂), lithium nickelate-cobaltate-aluminate (LiNi_{0.8}(CoAl)_{0.2}O₂) and Li—Mn spinel substituted with different elements, having the composition represented by Li₁₊ₓMn_{2-x-y}M_{y}O₄ (where M is one or more metal elements selected from among Al, Mg, Co, Fe, Ni and Zn).

The positive electrode active material is not particularly restricted, and it may have a covering layer. The covering layer is a layer comprising a substance that exhibits lithium ion conductivity, has low reactivity with the positive electrode active material or solid electrolyte, and can maintain the shape of the covering layer without flowing even when contacting the active material or solid electrolyte. Specific examples of materials to form the covering layer include, but are not limited to, LiNbO₃, Li₄Ti₅O₁₂ and Li₃PO₄.

The form of the positive electrode active material may be any common form used as a positive electrode active material for a solid-state battery, without any particular restrictions. The positive electrode active material may be particulate, for example. The positive electrode active material may be primary particles, or secondary particles which are aggregates of multiple primary particles. The mean particle diameter D₅₀ of the positive electrode active material may be 1 nm or greater, 5 nm or greater or 10 nm or greater, and 500 μm or smaller, 100 μm or smaller, 50 μm or smaller or 30 μm or smaller, for example. The mean particle diameter D₅₀ is the 50% cumulative particle diameter (median diameter) in the volume-based particle size distribution determined by laser diffraction/scattering.

The solid electrolyte, conductive aid and binder in the positive electrode active material layer may be selected with reference to the above description under “<Negative electrode active material layer>”.

The form of the positive electrode active material layer is not particularly restricted, and it may be an essentially flat sheet-like positive electrode active material layer. The thickness of the positive electrode active material layer is not particularly restricted and may be 0.1 μm or greater, 1 μm or greater or 10 μm or greater, and 2 mm or smaller, 1 mm or smaller or 500 μm or smaller, for example.

The positive electrode active material layer can be produced by a publicly known method. For example, a positive electrode mixture containing the components mentioned above may be dry or wet molded to easily form a positive electrode active material layer. The positive electrode active material layer may be formed together with the positive electrode collector layer, or it be formed separately from the positive electrode collector layer.

### <Positive Electrode Collector Layer>

The material used in the positive electrode collector layer is not particularly restricted, and any one commonly used as a positive electrode collector in a solid-state battery may be employed as appropriate. The material used in the positive electrode collector layer may be Cu, Ni, Cr, Au, Pt, Ag, Al, Fe, Ti, Zn, Co or stainless steel, for example, with no limitation to these. The positive electrode collector layer may also have a coating layer on the surface, in order to adjust the resistance. The positive electrode collector layer may also have the aforementioned metal either plated or vapor deposited on a metal foil or substrate.

The form of the positive electrode collector layer is not particularly restricted and may be, for example, a foil, sheet, mesh or the like. A foil is preferred among these.

The thickness of the positive electrode collector layer is not particularly restricted, and may be 0.1 μm or greater or 1 μm or greater, and 1 mm or smaller or 100 μm or smaller, for example.

### <Collector Terminals>

The collector terminals may be electrically connected to the negative electrode collector layer, for example, or they may be electrically connected to a current collector foil as a positive electrode collector layer. The collector terminals may be electrically connected to a negative electrode collector tab connected to the negative electrode collector layer, or they may be electrically connected to a positive electrode collector tab connected to the positive electrode collector layer. The material of the collector terminals is not particularly restricted and may be a metal such as aluminum or stainless steel (SUS).

### <Laminate Film>

The laminate film has a fusion layer and a metal layer. The laminate film is not particularly restricted and may have a fusion layer, a metal layer and a resin layer, in that order.

### (Fusion Layer)

The material of the fusion layer is not particularly restricted, and it may be a polyolefin resin. Examples of polyolefin resins include polypropylene (PP) and polyethylene (PE), with no restriction to these. The thickness of the fusion layer is not particularly restricted and may be 30 μm or greater, 40 μm or greater or 50 μm or greater, and 110 μm or smaller, 100 μm or smaller or 90 μm or smaller.

### (Metal Layer)

Examples for the material of the metal layer include aluminum, aluminum alloys and stainless steel, for example, with no limitation to these. The thickness of the metal layer is not particularly restricted and may be 20 μm or greater, 30 μm or greater or 40 μm or greater, and 70 μm or smaller, 60 μm or smaller or 50 μm or smaller.

### (Resin Layer)

Examples for the material of the resin layer include polyethylene terephthalate and nylon, with no limitation to these. The thickness of the resin layer is not particularly restricted and may be 70 μm or greater, 80 μm or greater or 90 μm or greater, and 270 μm or smaller, 250 μm or smaller or 230 μm or smaller.

Embodiments of the electrode stack and solid-state battery of the disclosure were described above, but a person skilled in the art will readily appreciate that modifications may be made that do not deviate from the scope of the claims.

### REFERENCE SIGNS LIST

10 Solid-state battery
100 Electrode stack
110 Stacked battery unit
110a First edge
110b Second edge
111 Negative electrode collector layer
111a Negative electrode stack connecting part
111b Extending side of negative electrode stack connecting part
111c Negative electrode collector layer at side opposite extending side of negative electrode
stack connecting part
112 Negative electrode active material layer
113 Solid electrolyte layer
114 Positive electrode active material layer
115 Positive electrode collector layer
115a Positive electrode stack connecting part
115b Extending side of positive electrode stack connecting part
115c Positive electrode collector layer at side opposite extending side of positive electrode stack connecting part
120 Unit cell
200 Collector terminal
300 Laminate film

1. An electrode stack having a plurality of stacked battery units,
wherein the plurality of stacked battery units each have at least a negative electrode collector layer, a negative electrode active material layer, a solid electrolyte layer, a positive electrode active material layer and a positive electrode collector layer, in that order,
(i) the negative electrode collector layer extends from the first edge of the stacked battery unit, and the plurality of stacked battery units are stacked together so that the plurality of first edges are in an inclined arrangement, and/or
(ii) the positive electrode collector layer extends from the second edge of the stacked battery unit, and the plurality of stacked battery units are stacked together so that the plurality of second edges are in an inclined arrangement.

2. The electrode stack according to claim 1, wherein the plurality of stacked battery units all have the same shape.

3. The electrode stack according to claim 1,
which satisfies (i) and (ii) above, and
wherein the first edges and second edges are mutually opposite edges of the stacked battery unit.

4. A solid-state battery comprising:
an electrode stack according to claim 1,
collector terminals, and
a laminate film sealing the electrode stack together with the collector terminals,
wherein:
(a) the negative electrode collector layers of the plurality of stacked battery units or the negative electrode collector tabs connected to the negative electrode collector layers are mutually stacked as a foil to form a negative electrode stack connecting part, and the negative electrode collector layers and/or the negative electrode collector tabs are bent so that the negative electrode stack connecting part is connected to the end face of the collector terminal facing the first edge of the electrode stack terminal, at the extending side of the negative electrode stack connecting part, where the extending side of the negative electrode stack connecting part is the surface on the side among the sides of the negative electrode stack connecting part where the plurality of first edges extend, and which are disposed at an inclination,
and/or
(b) the positive electrode collector layers of the plurality of stacked battery units or the positive electrode collector tabs connected to the positive electrode collector layers are mutually stacked as a foil to form a positive electrode stack connecting part, and the positive electrode collector layers and/or positive electrode collector tabs are bent so that the positive electrode stack connecting part is connected to the end face of the collector terminal facing the second edge of the electrode stack terminal, at the extending side of the positive electrode stack connecting part, where the extending side of the negative electrode stack connecting part is the surface on the side among the sides of the negative electrode stack connecting part where the plurality of second edges extend, and which are disposed at an inclination.
